(19) United States
(12) Patent Application Publication
(10) Pub. No.: US 2025/0011641 A1
(43) Pub. Date: Jan. 9, 2025

(54) FORMULATION OF FRICTION REDUCING AGENT, METHOD FOR REDUCING FRICTION IN TURBULENT FLOW AND USE OF FRICTION REDUCING AGENT

(71) Applicants: PETRÓLEO BRASILEIRO S.A. - PETROBRAS, Rio de Janeiro (BR); UNIVERSIDADE FEDERAL DO ESPIRITO SANTO - UFES, Victoria (BR)

(72) Inventors: Marcia Cristina Khalil De Oliveira, Rio de Janeiro (BR); Osvaldo Karnitz Junior, Rio de Janeiro (BR); Carmen Lucia Da Silva Teixeira, Rio de Janeiro (BR); Kelvin Cristien De Oliveira Barbosa, Vitoria (BR); Antonio Mauricio Chagas Maciel, Rio de Janerio (BR); Plinio Martins Dias Da Silva, Rio de Janeiro (BR); Edson Jose Soares, Victoria (BR)

(21) Appl. No.: 18/752,217

(22) Filed: Jun. 24, 2024

(30) Foreign Application Priority Data
Jul. 6, 2023 (BR) 10 2023 013583 8

(51) Int. Cl. C09K 8/588

(52) U.S. Cl. CPC C09K 8/588; C09K 2208/34

(57) ABSTRACT

The present invention relates to a formulation of a low viscosity friction reducing agent, based on high molecular weight polyisobutylene in mineral oil, for application in two-phase and multiphase turbulent flow in oil production lines, preferably in umbilicals. Particularly, the product is specified for meet the technical requirements for subsea injection in production systems with wet completion and two-phase turbulent flow (liquid-gas) and multiphase (liquid-liquid-gas) with a gas-oil ratio (GOR) of 150 to 1,500 m³/m³, as it is the case of oil and gas extraction systems in pre-salt. The present invention also relates to a method for reducing friction in turbulent flow comprising the subsea injection of said formulation and the use of this formulation to reduce friction in two-phase or multiphase flow in subsea oil production lines.

### FIELD OF THE INVENTION

The present invention falls within the field of chemical and mechanical engineering, more precisely in the area of friction reducing agents, and describes a formulation for a low viscosity friction reducing agent for application in two-phase or multiphase turbulent flow in oil production lines, preferably in umbilicals. Particularly, the product is specified for meet the technical requirements for subsea injection in production systems with wet completion and two-phase (liquid-gas) and multiphase (liquid-liquid-gas) turbulent flow with a gas-oil ratio (GOR) of 150 to 1,500 m³/m³, as is the case of oil and gas extraction systems in pre-salt. The present invention also relates to a method for reducing friction in turbulent flow comprising the subsea injection of said formulation and the use of this formulation to reduce friction in two-phase or multiphase turbulent flow in oil production subsea lines.

### BACKGROUND OF THE INVENTION

At the end of the 19^{th} century, during pump performance test, the occurrence of fluctuations in flow, of around 10%, in water originating from natural reservoirs, was observed. A few decades later, such flow variations were attributed to the presence of substances of a polymeric nature, produced by algae (Bizotto, 2011).

However, only in 1948, the first systematic study on the reduction of hydrodynamic friction was published by the British chemist B. A. Toms (Toms, 1948). In these studies, it was shown that dilute solutions of polymethylmethacrylate, dissolved in chlorobenzene, under certain turbulent flow conditions had lower pressure loss in relation to pure solvent flow. In 1960, New York firefighters began dosing polyethylene glycols in firefighting water and this provided an increase in the flow rate and range of the firefighting water jet (Bailey and Koleske, 1976).

In theory, this hydrodynamic friction reduction effect can occur in any fluid under turbulent flow containing the drag or friction reducing agent. Friction reducing agent is any substance that, in the turbulent flow of a certain fluid, allows to increase the flow, maintaining the head loss and same energy consumption, or that reduces head loss (and energy consumption) without changing the flow rate. The temperature is a variable that affects the ability of the friction reducing agent in reducing hydrodynamic friction, since it changes its molecular conformation and, consequently, the interaction of the substance with turbulence.

Studies related to the application of friction reducing agents in single-phase flow are very more advanced when compared to works addressing the application of friction reducing agents in multiphase flow. The concomitant flow of gas, oil and water is a very common occurrence in the oil industry and the subsea injection of friction reducing agents could promote the reduction of pressure loss and/or increase the flow capacity of the production system (Al-Wahaibi et al., 2014).

Friction reducing agents are chemical products that, added in small concentrations to the fluid (on the order of parts per million), have the potential to reduce the hydrodynamic friction of the flow. The expression friction reduction (or drag) is used in the literature to designate the pressure gradient reduction observed in turbulent flows in pipelines, resulting from the addition of small amounts of certain substances to the liquid phase. Thus, the use of friction reducing products has the following advantages: (i) increased drainage capacity of the piping (yield); (ii) savings in power pumping (OPEX); (iii) pressure reduction, providing the associated reductions in pipe thickness (CAPEX); (iv) reduction in the number or size of pumping (CAPEX) (Jubran; Zurigat and Goosen, 2005).

Friction reducing agents can be classified into three groups: fibers; polymers; and surfactants. Fiber suspensions provide a significant reduction in friction, but its commercial and industrial use is very limited due to the high probability of fibers promote clogging of equipment and pipes (Lee, 1976). Polymers are the friction reducing agents that have been most extensively studied and are the active material of most commercial products (Yu and Li, 2004). Friction reducing products with surfactants such as active material began its development in the 80's and already have some industrial applications, such as in heating and cooling water closed circuits (Krope and Lipus, 2010).

Polymers are the active material of the most studied friction reducing circuits, however, have as main disadvantage the possibility of mechanical or thermal degradation of the molecules during flow, causing reduction of performance in reducing friction, with no possibility of regeneration. Currently, the degradation of polymers from friction reducing agent products is the main obstacle to the development of more efficient additives for long flow lines, being an impediment to use of this active material in closed systems. The degradation of polymers in the flow is directly related to the turbulence of the medium, the geometry of the flow, the type of fluid and the type of polymer. Temperature and pressure may also influence the degradation of polymers (White and Mungal, 2008).

The polymer degradation mechanism is related to the shear of macromolecules which, when exposed to the tensions exerted by the flow, have their polymeric chain (and, consequently, its molecular mass) reduced. Such degradation leads to a reduction in friction reducer performance to a minimum value, from which no further reduction is observed (Soares, 2015).

In general, surfactant product molecules are much smaller than polymers. The actuation mechanism of surfactants in reducing friction consists of the fact that these molecules aggregate in the liquid in the form of large micelles. Therefore, the main advantage of surfactant-based friction reducing products is the ability of these molecules to restore the micellar structure responsible by reducing friction after the destruction of these micelles by stresses exerted by the flow. This feature is necessary in closed circuits, such as fluids used in urban heating. Surfactant molecules used for this application are amphiphilic compounds, consisting of long hydrophobic tails and hydrophilic heads.

Micellization, that is, the formation of surfactant aggregates called micelles, is a consequence of the driving force to minimize contact between the fluid and part of the surfactant with different characteristics from the liquid. The micelles begin to appear in the liquid after a certain concentration, which is called critical micelle concentration (CMC). At concentrations greater than the first CMC, sphere-like micelles are formed. However, this micellar form does not yet have friction reducing action. For reduction of friction, the surfactant concentration must be above the second CMC, wherein the micelles are arranged in the form of rods (Kotenko et al., 2019).

Currently, there are no friction reducing agents for application in high-flow production lines that flow light oil in a multiphase regime (liquid-gas) injected through subsea umbilical commercially available yet. The major impediments are related to high viscosity and heterogeneity of commercial products which make it impossible to inject the product through long umbilical lines.

The inventors of the present invention evaluated the application potential of commercial friction reducing agents, received from traditional suppliers, and no product had concomitant approval for performance and technical specification for subsea injection. From these results, it was necessary to dedicate efforts to the development of a new formulation to meet technological demand.

Particularly, for subsea injection of products, these must be a solution that shows low viscosity (less than 100 mPa·s) at 4° C., thermal stability at high and low temperatures, which does not lose the solvent in the flow conditions through the umbilical, in addition to being compatible with metallic and non-metallic materials and with solvents.

### STATE OF THE ART

Some documents from the state of the art describe formulations of friction reducing agents, such as those indicated below.

The patent document US 2009/227729 A1 entitled “LOW-VISCOSITY DRAG REDUCER” relates to low-viscosity drag reducer agents, particularly with viscosity less than 350 mPa·s (350 cP) at a shear rate of 250 s⁻¹ and temperature of approximately 15° C. (60° F.), which are suitable for use in long and narrow umbilicals, without causing clogging.

The document describes several polymers that can be used in the product, including polyolefins, polyisobutylene (PIB), polyacrylates, polystyrene derivatives, polydimethylsiloxane, polyisoprene, polybutadiene, cyclopentene polymers and copolymers of cyclopentene with other hydrocarbons such as isobutene, octene, butadiene and isoprene. The solvent used can be aqueous or a hydrocarbon, straight chain aliphatic compounds or branched hydrocarbons being mentioned as suitable hydrocarbons, such as pentane, hexane, heptane or octane, as well as alicyclic hydrocarbons such as cyclohexane, methyl cyclopentane and tetralin, and aromatic hydrocarbons such as benzene, toluene, xylene and mixtures of these compounds.

From the considerably broad description of potential polymers and solvents, the document defines as preferred in the examples, diisobutyl aluminum chloride monomers and the solvents, rafinate and decene.

However, the document does not disclose the specific characteristics that must be met to allow injection into a wet Christmas tree, through subsea, at low temperatures (<15° C.) through injection subsea lines (umbilicals), namely: viscosity less than 100 mPa·s at 4° C., thermal stability in high temperature (110° C.), at low temperatures (4° C.) and at oscillation between high (110° C.) and low (4° C.) temperature, compatibility with metallic and non-metallic materials, flash point above 60° C., without significant loss of solvent, with low solids content in the formulation and does not compromising the oil-water and gas-liquid separation process on the platform or the quality of oil and gas produced. Furthermore, the document does not disclose the molecular weight of the polymers formed in the examples or mineral oils used as solvents in the product of the present invention.

The scientific article entitled “Universal Characteristics of Drag Reducing Polyisobutylene in Kerosene” relates to a study of a series of oil-soluble polyisobutylenes in kerosene as a drag reducing agent in turbulent flow. The document teaches that the concentration of the polymer in the solution used has influence on drag reduction. It was also reported that the maximum concentration for a drag reduction decreases with increasing molecular weight.

However, the drag reducing agent analyzed in the document is solubilized in kerosene. Kerosene does not meet the requirements to be a suitable solvent for umbilicals, since their flash point is lower than 60° C. The aforementioned article does not allow us to conclude that PIB would be suitable for formulation into a drag reducing agent for subsea injection, especially considering that the PIB is a high molecular weight and high viscosity product. For injection into umbilicals, it is extremely important that the drag reducing product used has a low viscosity, particularly less than 100 mPa·s at 4° C.

The scientific document entitled “Estudo Experimental Da Redução De Arrasto Por Poli-Isobutileno E Os Efeitos Da Pré-Diluição Em Solventes E Degradaçáo Mecânica Em Escoamento Turbulento” (Experimental study of drag reduction by polyisobutylene and the effects of pre-dilution in solvents and mechanical degradation in turbulent flow) reports an evaluation of the rheological behavior of high molar mass PIB mixtures in different concentrations to understand how rheological characteristics can impact the phenomenon of reduction of hydrodynamic friction and to verify the impact of using solvent in the prior dispersion of these polymers, which are supplied in solid state in the form of large bars. Among the solutions evaluated in this document are those involving PIB of 1.0×10⁶ g/mol and 4.2×10⁶ g/mol in kerosene and 5% cyclohexane, for subsequent dilution to 0.05%, 0.1% and 0.2%. The document teaches that interaction polymer/solvent is one of the factors that influence the friction reduction effect.

However, the document uses solvents that do not meet the requirements for subsea injection through umbilical in production systems with wet completion, as they do not have a flash point above 60° C. The document also does not provide lessons that could indicate to the person skilled in the art that PIB solutions in mineral oils could meet the necessary requirements for application in subsea umbilicals according to the products of the invention. It is noteworthy that the document shows the importance of the PIB/solvent binomial for the reducing friction effect.

The scientific document entitled “EFFECTIVENESS OF POLYISOBUTYLENE AS DRAG REDUCING AGENT IN TURBULENT PIPE FLOW” relates to the study of the effectiveness of drag reducing in turbulent flow through polyisobutylene, opanol B 250 type, in a closed-circuit circulation system of accumulation under different flow conditions. PIBs of 2.5×10⁶, 4.1×10⁶ and 5.9×10⁶ g/mol, diluted in reformate and kerosene were used. The higher the concentration of polyisobutylene used, the greater the drag reduction observed. Kerosene was indicated as a good solvent, since it has low viscosity and allows greater percentage of drag reduction at higher concentrations.

As in the previous case, the document uses solvents that do not meet the requirements for subsea injection through an umbilical in production systems with wet completion, since they do not present the flash point above 60° C., or that are different from those of the present invention. The document also does not provide teachings that could indicate to the person skilled in the art which PIB solutions in mineral oils could meet the requirements necessary for application in subsea umbilicals as per the products of the invention.

The patent document EP 0 790 071 A1, entitled “PREVENTION OF SHEARING OF DROPLETS TO AEROSOL SIZES”, discloses the use of polyisobutylene in predominantly gaseous streams to prevent rupture of hydrocarbon droplets in the stream in aerosol size, due to a decrease in droplet drag. The document teaches that polyisobutylene is effective as a drag reduction agent in mostly gaseous flows.

However, the teachings of such document could not suggest that PIB would be suitable as a low viscosity friction reducing agent for application in two-phase and multiphase turbulent flow in oil production lines, particularly in umbilicals, in production systems with wet completion and two-phase (liquid-gas) and multiphase (liquid-liquid-gas) turbulent flow with a gas-oil ratio (GOR) of 150 to 1,500 m³/m³. This is because the application scenario of the product of the present invention is distinct from that of this document, not being mostly gaseous.

Furthermore, the patent document WO 2021/067436 A1, entitled “ADDITIVES FOR POLYMER EMULSION STABILIZATION”, relates to polymeric oil-in-water emulsions that are stable under shear conditions and under storage in high temperatures (up to 60° C.) or low temperatures (≤−6.7° C.). Such compositions are useful as friction reducing agents in subsea lines by umbilicals.

However, the document shows a solution different from that proposed by the inventors of the present invention to reduce friction in umbilical systems. Moreover, the document suggests that high molecular weight polymers traditionally used as friction reducing agents would not be suitable for application in umbilicals.

### SUMMARY OF THE INVENTION

The present invention aims to propose, firstly, a formulation of a friction reducing agent comprising a high molecular weight PIB dissolved in mineral oil. Surprisingly, such a formulation, selected by an ideal combination between polymer and solvent, meets the necessary requirements for injection subsea through wet Christmas tree, through umbilical located at the bottom of the well, through a chemical injection valve (downhole) and through the gas injection valve in the well (gas lift). In a preferred embodiment, the formulation is for subsea injection in production systems with wet completion and two-phase (liquid-gas) and multiphase (liquid-liquid-gas) turbulent flow with gas-oil ratio (GOR) of 150 to 1,500 m³/m³, as is the case with oil extraction systems in the pre-salt region.

In a second embodiment, the present invention relates to a method for reducing friction in turbulent flow comprising subsea injection of the formulation of friction reducing agent comprising a high molecular weight PIB dissolved in mineral oil, wherein the injection occurs through the umbilical on a wet Christmas tree, through the downhole umbilical or through gas lift. There are no records in the technical literature of using this method by other oil and gas production companies in Brazil and around the world.

In a third embodiment, the present invention relates to the use of a formulation of friction reducing agent comprising a high molecular weight PIB dissolved in mineral oil to reduce friction in turbulent flow, through subsea injection through the umbilical into the wet Christmas tree, through downhole umbilical or through gas lift.

### BRIEF DESCRIPTION OF THE FIGURES

To obtain a full and complete view of the objective of the present invention, the Figures to which reference is made are indicated as follows.

FIG. 1 is a graphical representation of the performance in reducing friction of PIB-based products 4 MM (4.0×10⁶ g/mol) and 8 MM (8.0×10⁶ g/mol) of the invention and PIB 8 MM in kerosene (PIB8MMQ), in a flow unit by evaluating pressure loss, of samples of liquids with and without PIB-based formulations.

FIG. 2 is a graphical representation of the degradation of products based on PIB 4 MM and PIB 8 MM of the invention and in kerosene (PIB8MMQ), depending on the number of passes in centrifugal pump in the flow unit in closed circuit.

FIG. 3 illustrates the static thermal stability test at cold (4° C.) and hot (80° C.) of the PIB-based product with a molecule of 4 MM of diluted molecular weight in monoalkylbenzene derivatives and hydrotreated light oil distillates (here indicated as PIB4MM), during the period of 30 days.

FIG. 4 illustrates in (a) the appearance of the product PIB4MM before (left) and after (right) the cold stress test (4° C.) for 168 hours and in (b) the appearance of the PIB-based product with a molecule with 8 MM molecular weight diluted in hydrotreated light oil distillates (here indicated as PIB8 MM) before (left) and after (right) the cold stress test (4° C.) for 168 hours.

FIG. 5 illustrates in (a) the appearance of the product PIB4MM before (left) and after (right) the hot stress test (80° C.) for 168 hours and in (b) the appearance of the PIB8 MM product before (left) and after (right) the hot stress test (80° C.) for 168 hours.

FIG. 6(a) illustrates the appearance of the PIB4MM product at the bottom of the U-tube before (left) and after (right) the glass capillary tube heating evaporation test at 80° C. for 192 hours. FIG. 6(b) illustrates the appearance of the PIB8 MM product at the bottom of the U-tube before (left) and after (right) the glass capillary tube heating evaporation test at 80° C. for 192 hours.

FIG. 7 (a) illustrates the meniscus of the U-tube with the PIB4MM product before (left) and after (right) the glass capillary tube heating evaporation test at 80° C. for 192 hours. FIG. 7 (b) illustrates the meniscus of the U-tube with PIB8 MM product before (left) and after (right) the glass capillary tube heating evaporation test at 80° C. for 192 hours.

FIG. 8 illustrates the appearance of PIB4MM and PIB8 MM products after compatibility tests with cold (4° C.) and hot (80° C.) diesel.

FIG. 9 illustrates the appearance of PIB4MM and PIB8 MM products after compatibility tests with cold (4° C.) and hot (80° C.) monoethylene glycol (MEG).

FIG. 10 illustrates the appearance of the PIB8 MM product with a scale inhibitor used in pre-salt production units.

FIG. 11 illustrates the appearance of the PIB4MM product with a scale inhibitor product used in pre-salt production units.

FIG. 12 illustrates the appearance of the metallic surfaces (test specimen) in (a) carbon steel, in (b) 316 steel and in (c) L-80-Cr-13 steel, after contacting with the PIB4MM product (for 30 days at 40° C.).

FIG. 13 illustrates the viscosity of the PIB4MM and PIB8 MM products at atmospheric pressure and 20 MPa, at different temperatures and shear rates.

FIG. 14 graphically illustrates the influence of the PIB4MM and PIB8 MM products in separating water from the emulsion of an oil sample from a pre-salt well (scenario I), with addition of 50 ppm of demulsifier, at 40° C.

FIG. 15 illustrates the influence of the PIB4MM and PIB8 MM products in the aspect of water separated from the emulsion of an oil sample from a pre-salt well (scenario I), with addition of 50 ppm of demulsifier, at 40° C.

FIG. 16 graphically illustrates the influence of the PIB4MM and PIB8 MM products in separating water from the emulsion of an oil sample from a pre-salt well (scenario II), with addition of 50 ppm of demulsifier, at 50° C.

FIG. 17 illustrates the influence of the PIB4MM and PIB8 MM products in the aspect of water separated from the emulsion an oil sample from a pre-salt well (scenario II), with addition of 50 ppm of demulsifier, at 50° C.

FIG. 18 graphically illustrates the influence of the PIB4MM and PIB8 MM products in the formation and breakdown of foam in an oil sample from a pre-salt well (scenario I) at room temperature in the laboratory.

FIG. 19 graphically illustrates the influence of the PIB4MM and PIB8 MM products in the formation and breakdown of foam in an oil sample from a pre-salt well (scenario II) at room temperature in the laboratory.

### DETAILED DESCRIPTION OF THE INVENTION

The present invention aims to propose, firstly, a formulation of a friction reducing agent comprising a high molecular weight PIB dissolved in mineral oil. Surprisingly, this formulation meets the necessary requirements for subsea injection through wet Christmas tree, through umbilical downhole and through gas lift.

In a preferred embodiment, the formulation is suitable for subsea injection in production systems with wet completion and two-phase (liquid-gas) and multiphase (liquid-liquid-gas) turbulent flow with gas-oil ratio (GOR) of 150 to 1,500 m³/m³, more preferably of 150 to 600 m³/m³, as is the case with pre-salt oil and gas extraction systems.

In an alternative preferred embodiment, the formulation for subsea injection in turbulent flow regime of medium and low-density oils (medium and light), wherein the water content is less than 10%, with a Reynolds number in flow greater than 10,000 and/or with flow speed less than 4.6 m/s.

In a preferred embodiment, the formulation of friction reducing agent comprises PIB polymers with molecular weight between 4 MM and 8 MM. Further preferably, the formulation of friction reducing agent comprises PIB polymers with a molecular weight of 8 MM.

In an even more preferred embodiment, the formulation of friction reducing agent comprises PIB polymers, dissolved in mineral oil at concentrations of 5,000 ppm to 15,000 ppm (0.5 to 1.5% m/m). Further preferably, PIB is dissolved in mineral oil of 5,000 ppm.

In a preferred embodiment, mineral oil has a flash point above 70° C. In one preferred embodiment, mineral oil is selected from monoacylbenzene derivatives (CAS 84961-70-6), hydrotreated light oil distillates (CAS 64742-47-8) and mixtures thereof. In a more preferred embodiment, the mineral oil is the mixture of monoacylbenzene derivatives (CAS 84961-70-6) with hydrotreated light oil distillates (CAS 64742-47-8), preferably in the ratio of approximately 1:3. Even more preferably, the mineral oil is composed of hydrotreated light oil distillates (CAS 64742-47-8).

In an even more preferred embodiment, the formulation of friction reducing agent comprises a PIB of 8 MM diluted in hydrotreated light oil distillates at 5,000 ppm. In an even more preferred alternative embodiment, the formulation of friction reducing agent comprises a PIB of 4 MM diluted in monoalkylbenzene derivatives (25%) and hydrotreated light oil distillates (73.5%) at 15,000 ppm.

Surprisingly, the formulation of friction reducing agent of the present invention meets the criteria for subsea injection through umbilicals. Such criteria were not met by any of the commercially available products evaluated by the inventors.

Furthermore, the subsea injection of the formulation of friction reducing agent of the present invention has the following benefits: increased flow rate in oil pipelines; reduction in operating pressure; reduction/increase in the number of pumps in operation in export pipelines and increase operational flexibility. The application of products from present invention leads to the reduction or postponement of investments in expansions of production systems and oil transfer, anticipation of production, gains in the amount of oil and reduction of CO₂ emissions.

In a second embodiment, the present invention relates to a method for reducing friction in turbulent flow comprising subsea injection of the formulation of friction reducing agent of the invention, wherein the injection is through umbilical in the wet Christmas tree, through downhole umbilical or through gas lift. In a preferred embodiment, the injection is through umbilical in a wet Christmas tree.

In a preferred embodiment, the formulation of friction reducing agent is applied at a concentration of 0.05% to 5%. Even more preferably, the formulation of friction reducing agent is applied at a concentration of 5%.

In a preferred embodiment, the method comprises: (i) injecting a formulation of friction reducing agent of the present invention at the end of the umbilical located on the surface; (ii) transporting the formulation of friction reducing agent of the present invention by the umbilical to the subsea environment; and (iii) injecting the formulation of friction reducing agent of the present invention in a second umbilical with a two-phase (liquid-gas) or multiphase (liquid-liquid-gas) turbulent flow fluid.

In a preferred embodiment, the method is to reduce friction in subsea turbulent flow of medium and low-density oils. In one preferred embodiment, the water content in the turbulent flow is lower than 10%, the Reynolds number in the flow is greater than 10,000 and/or the flow velocity is less than 4.6 m/s.

In a third embodiment, the present invention relates to the use of a formulation of friction reducing agent of the invention for reducing friction in turbulent flow, wherein the formulation is for subsea injection through umbilical in wet Christmas tree, through downhole umbilical or through gas lift. In a preferred embodiment, the injection is through the umbilical in a wet Christmas tree.

In a preferred embodiment, the use is in reduction of friction in subsea turbulent flow of low-density oils. In one preferred embodiment, the water content in the turbulent flow is lower than 10%, the Reynolds number of the flow is greater than 10,000 and/or the flow velocity is less than 4.6 m/s.

In a preferred embodiment, the use of formulation of friction reducing agent comprises the use of a concentration of 0.05% to 5%, preferably at a concentration of 5%.

To demonstrate its potential, the present invention will be described in more detail from the aspect of the embodied examples. It should be noted that the following description is solely for the purpose of clarifying the understanding of the proposed invention and disclosing, in more detail, the embodiment of the invention without limiting it to them. Therefore, variables similar to the examples are also within the scope of the invention.

### Example 1: Preparation of the Formulation of Friction Reducing Agent

For the preparation of formulations of friction reducing agent, polyisobutylene with a molecular weight of 4 MM and 8 MM was weighed and placed into contact with hydrotreated light oil distillates, a mixture of hydrotreated light oil distillates and monoalkylbenzene derivatives and kerosene (comparative example). The dilution occurred by diffusion, without agitation, in order to avoid polymer degradation. The amount of mineral oil for obtaining a formulation from 5,000 ppm to 15,000 ppm was weighed based on the initial amount of polymer.

Three formulations were developed: (i) PIB with molecular weight of 8 MM at 5,000 ppm in kerosene (called PIB8MMQ); (ii) PIB with molecular weight of 8 MM at 5,000 ppm in hydrotreated light oil distillates (CAS 64742-47-8) (called PIB8 MM); and (iii) PIB with a molecular weight of 4 MM at 15,000 ppm in 25% monoacylbenzene derivatives (CAS 84961-70-6) and 73.5% hydrotreated light oil distillates (CAS 64742-47-8) (called PIB4MM).

Table I shows the viscosity, density and the flash point of the PIB8 MM and PIB4MM formulations object of the present invention.

TABLE I
Physicochemical Properties of the Formulations
of Friction Reducing Agent

| | Viscosity at 4° | | |
|---|---|---|---|
| | C. and 10 s⁻¹ | Density at | Flash point |
| Formulation | (mPa · s) | 22° C. (g/mL) | (° C.) |
| PIB8MM | 43.0 | 0.8029 | >77 |
| | | | (ASTM D-93) |
| PIB4MM | 93.4 | 0.8189 | >70 |
| | | | (ASTM D-93/90) |

### Example 2: Performance Evaluation of the Formulation of Friction Reducing Agent

The evaluation of the friction reducing action was carried out using single-phase flow, in kerosene, at temperature of 25° C., in open circuit and using pumps. The tests were carried out in a pilot unit constituted of: pressurized and depressurized tanks for the fluids; separator vessel for mixing water and oil; compressor system; pump system for fluids and chemical additives; instrumentation for data control and acquisition. This pilot unit can perform tests in open (without fluid recirculation) and closed (with fluid recirculation) circuits and in flows consisting of single-phase (water or oil) and two-phase (water-oil) systems. Furthermore, fluid flow can be carried out by pump systems or by nitrogen pressurization. The tubing is made of stainless steel with an external diameter of 0.127 m (½ in) and can achieve flows at high Reynolds numbers (up to 65,000).

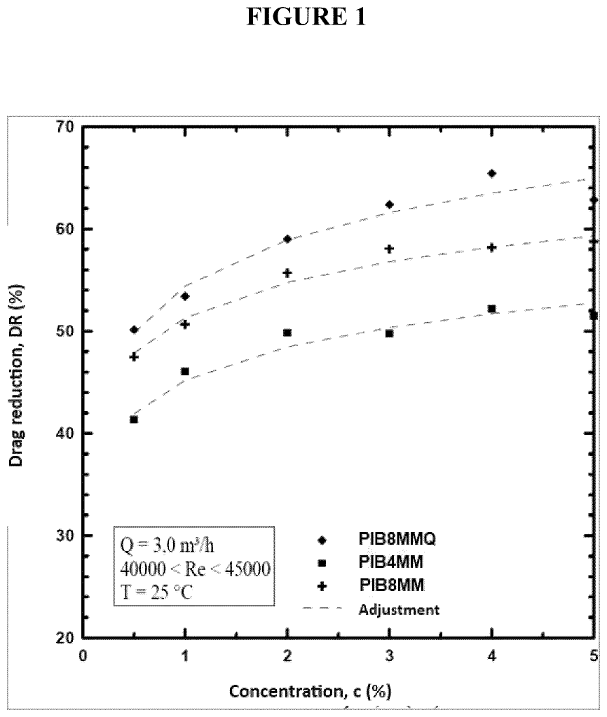

The results of the friction reducing action of the formulations of the invention in the PIB8 MM, PIB4MM and PIB8MMQ formulations are shown in FIG. 1. It is observed that as the concentration is increased, the drag reduction coefficient also increases, reaching values greater than 60% with active matter contents of the order of 250 ppm of PIB in the oil drained. In higher concentrations, the increase in PIB concentration does not result in significant gains of drag reduction, as the solution passes from diluted to concentrated, increasing the viscosity of the kerosene.

Furthermore, it is possible to verify that the concentrated solution of PIB, with molecular mass 8×10⁶ g/mol, diluted in kerosene, has higher drag reduction coefficients for different concentrations, followed by the PIB4MM and PIB8 MM formulations of the invention. Thus, the formulations of the invention prove to be a viable alternative to kerosene, which has an inadequate flash point for subsea injection in marine production systems.

The performance of the formulations was quantified through this flow test through head loss evaluation of liquid samples doped or not with the formulations. The head loss of the sample, in the absence of the formulation and at the same flow rate, is obtained using the correlation formula between flow rate and head loss (equation 1) for the sample.

Reducing head loss for the same volume flow (DR (%)) is quantified by comparing the pressure differential of the liquid sample, in the absence and presence of the chemical additive, as shown in Equation 1.

$$D R ( \% ) = \frac{100 \times ( Δ {P}_{0} - Δ {P}_{DRA} )}{Δ {P}_{0}} \qquad ( 1 )$$

where ΔP₀ and ΔP are the pressure differential, in constant and equal flow rate, in the absence and presence of the formulation of friction reducing agent, respectively.

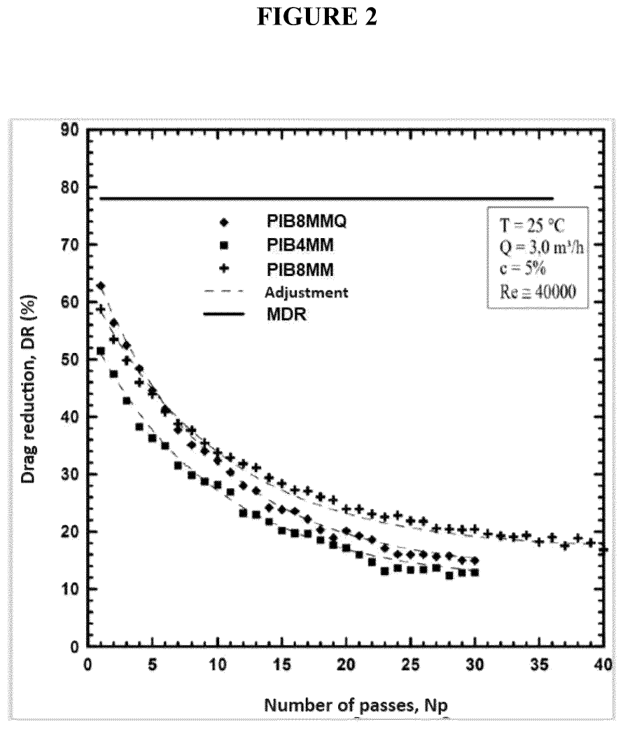

To evaluate the degradation of the products, closed circuit tests were also carried out, passing through several cycles in the centrifugal pump of the drainage unit. The results obtained are shown in FIG. 2. Based on these results, it is observed that the PIB8 MM product showed drag reduction slightly lower than PIB with a molar mass of 8.0×10⁶ g/mol at the beginning (up to Np=7), however, with a greater number of passes, the PIB8 MM product showed the best performance among the three analyzed, reaching asymptotic value of drag reduction around of 18%.

Furthermore, the PIB8 MM product reached the asymptotic level of drag reduction at higher number of passes (approximately 40 passes). Therefore, among the three tested products, the PIB8 MM product showed the highest resistance to mechanical degradation in turbulent flow in ducts.

### Example 3: Evaluation of Compliance with the Criteria for Subsea Injection by Formulations of Friction Reducing Agent

### 3.1 Thermal Stability

Changes in product stability may occur when exposed to very different conditions, such as for example, at high (bottom of the well or in the surface or platform (topside)) and low (umbilical on the section close to ANM) temperatures. The thermal stability test at 4° C. and the Maximum Temperature (Tmax) aims to evaluate the behavior of products for a minimum period of 30 days, with visual monitoring and photographic recording of variations observed in the fluid after 7, 14, 21 and 30 days. The tests were carried out in a glass container with a lid, inert to the chemicals, and taking into account the resistance of the container material at the test temperature.

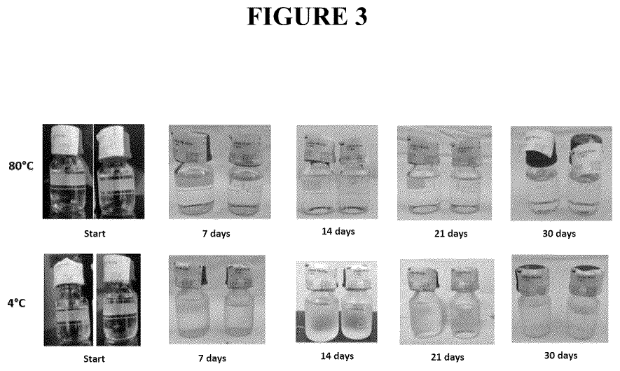

FIG. 3 shows photos of the PIB4MM product subjected to cold (4° C.) and hot (80° C.) static thermal stability test, during a period of 30 days. As can be observed, there was no change in the appearance of the product, that is, it remained stable, without the formation of sludge, precipitates or turbidity during the period of the stability test.

### 3.2 Hot and Cold Stress Tests (Hot Stress and Cold Stress)

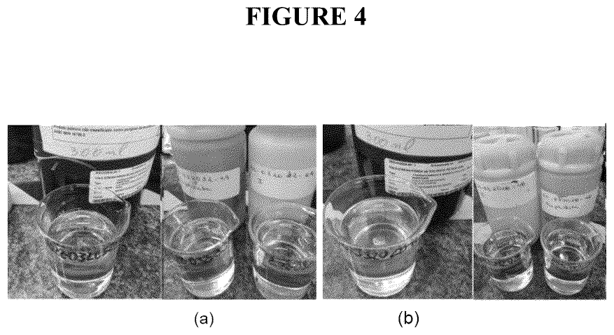

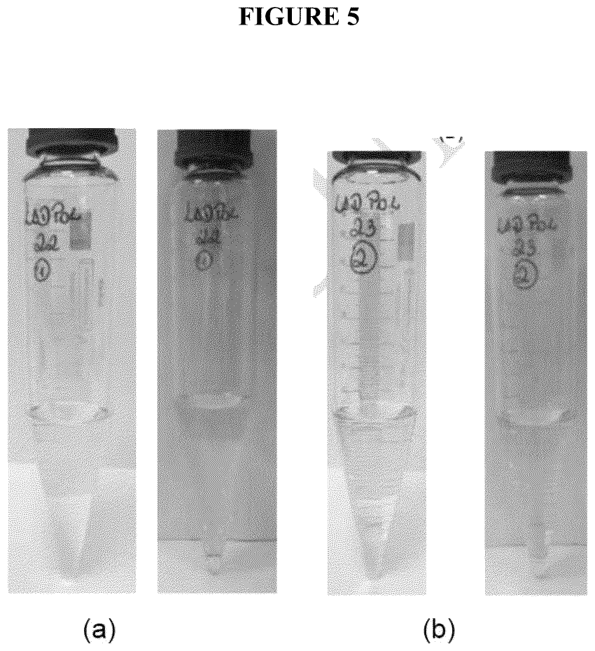

The stress test aims to evaluate the stability of chemicals in extreme conditions. This test proposes to submit the product in a centrifuge under acceleration of 9806.65 m/s² at temperatures of 4° C. and 80° C. for 168 hours. FIGS. 4 and 5 show the appearance of the product samples in cold stress and hot stress, respectively. As can be seen, in both tests there was no change in the appearance of the products after 168 h under centrifugal agitation at the temperatures defined for the test.

### 3.3 Solvent Loss

During the injection through umbilical there is the possibility of the spine breakage phenomenon to occur, that is, the formation of a vacuum inside the umbilical in events of interruption of product injection, or even when the injection flow rate is too low. Spine breakage may occur both below and above the ANM, depending on the conditions from the well, which may result in evaporation of part of the solvent and consequent appearance of solids. Therefore, this test aims to evaluate the impact of solvent loss on product properties.

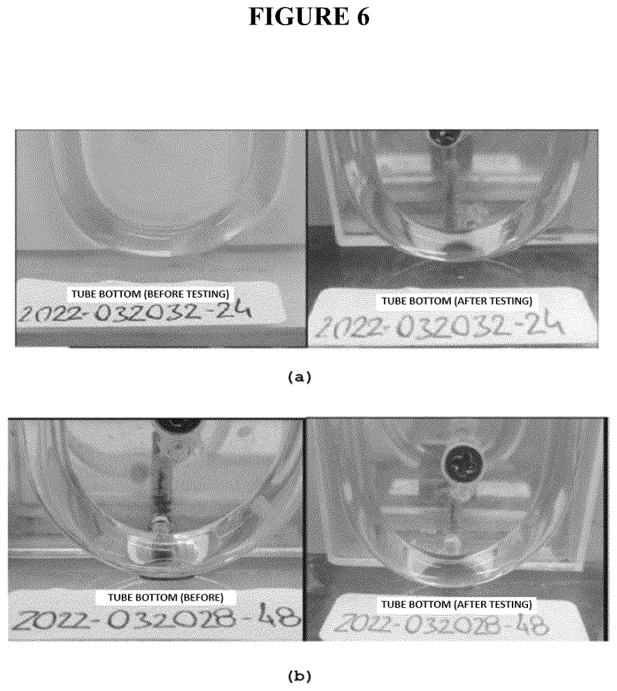

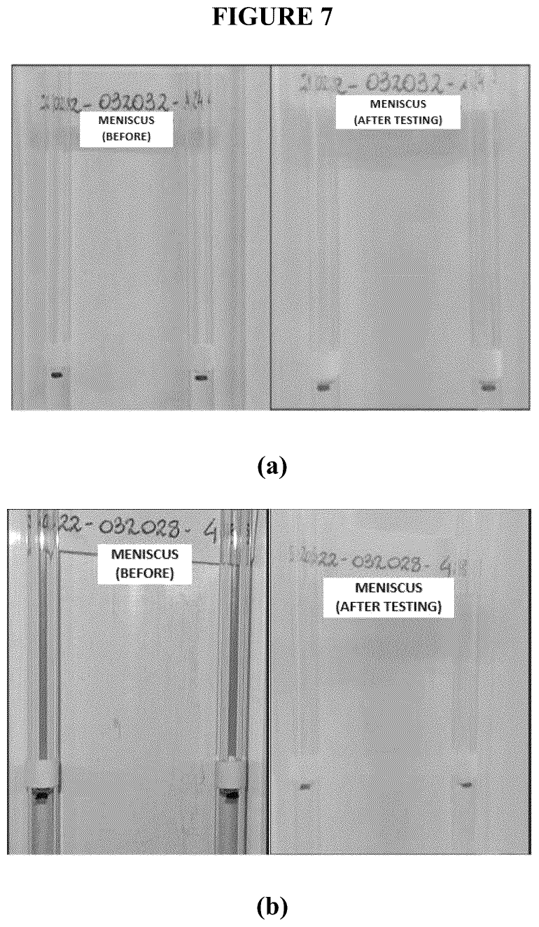

The formulations were subjected to a heating evaporation test in a U shape glass capillary tube of 50 cm long and 6 mm in diameter at Tmax (80° C.) for 192 hours, under atmospheric pressure. The tube was filled with the formulations in a sufficient amount to reach a height of 25 cm. The solvent loss was evaluated by the difference between the initial and final height in the temperature test. As can be seen in FIGS. 6 and 7, there was no change in the meniscus nor the presence of precipitate, sludge or significant increase in viscosity (visual observation). In this way, the formulations were considered approved.

### 3.4 Solvent Compatibility

The compatibility evaluation of the formulations with solvents typically available in production units, which are used in injection lines, such as marine diesel and monoethylene glycol (MEG).

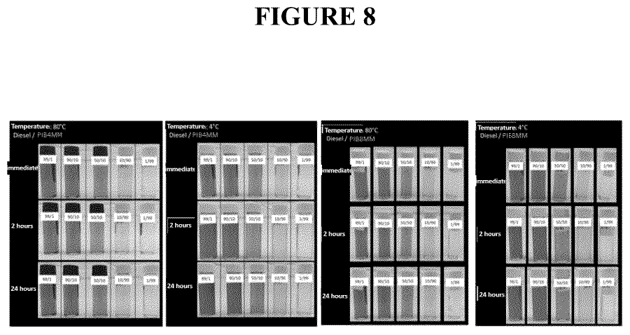

FIG. 8 shows photos of the test evaluation of the compatibility of the PIB4MM and PIB8 MM formulations with diesel in different mixture ratios (1/99, 10/90, 50/50, 90/10, 99/1), cold (4° C.) and hot (80° C.) for 24 hours. It can be seen that the products are miscible in diesel in all ratios.

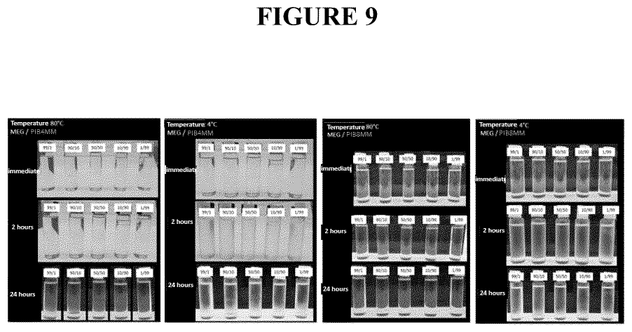

FIG. 9 shows photos of the test evaluation of the compatibility of the PIB4MM and PIB8 MM formulations with MEG in different mixture ratios (1/99, 10/90, 50/50, 90/10, 99/1), cold (4° C.) and hot (80° C.) for 24 hours. It can be seen that the products are immiscible in MEG in all ratios and that there is no turbidity or formation of precipitates in the samples under the evaluated conditions.

### 3.5 Scale Inhibitor Compatibility

At this stage, compatibility was evaluated between the PIB4MM and PIB8 MM formulations and the scale inhibitor products commonly used, injected through umbilical.

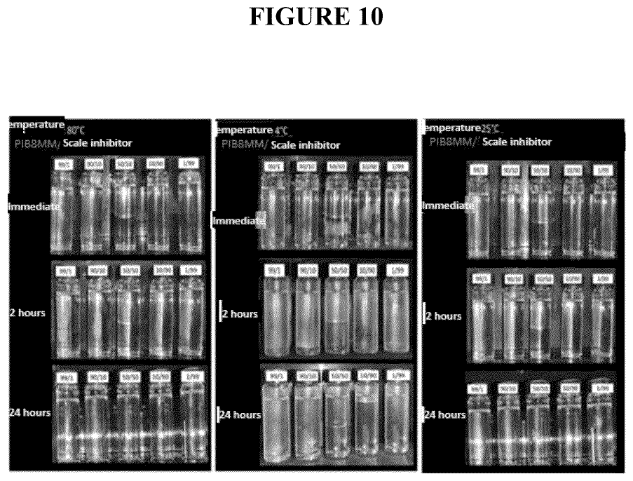

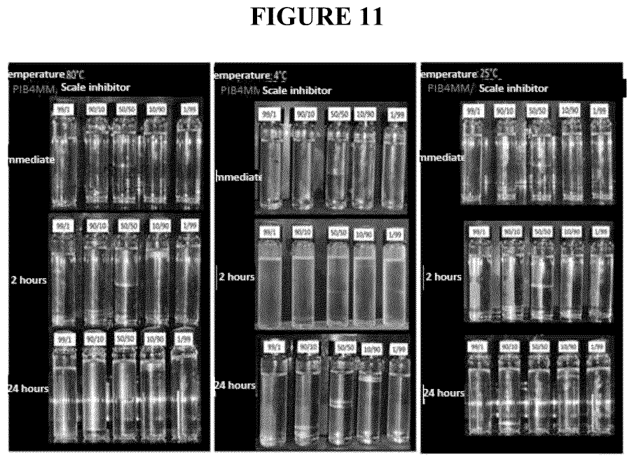

FIGS. 10 and 11 show photos of the evaluation test of compatibility between products and a scale inhibitor (combination of sodium salt of phosphonomethylated diamine, sodium phosphorite, monoethylene glycol and ethanol) used in pre-salt production scenarios, in different mixture ratios (99/1, 90/10, 50/50, 10/90, 1/99), at temperatures of 80° C., 4° C. and 25° C., evaluated immediately, after 2 hours and after 24 hours. It can be observed that the products are immiscible in all ratios and there is no turbidity or formation of precipitates. These results were expected since the PIB4MM and PIB8 MM formulations are oil-based and scale inhibitors are aqueous-based, that is, they are of opposite natures and, thus, become immiscible.

### 3.6 Corrosivity

The corrosivity of the PIB4MM and PIB8 MM formulations was evaluated with metallic materials: low resistance carbon steel (40° C.), in AISI 316L stainless steel and L-80-Cr13 (or AISI 410 stainless steel), both at maximum temperature of 60° C. according to ASTM G31 (Standard Guide for Laboratory Immersion Corrosion Test of Metals). Each material was tested in triplicate, with the samples remaining completely immersed in the product, packed in a sealed inert container.

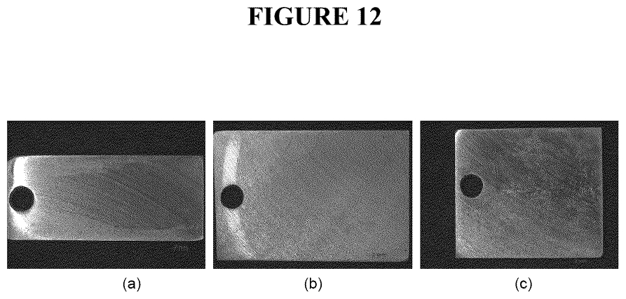

After carrying out the corrosivity test, the specimens were recorded using a Zeiss stereoscope, model SZ61, before and after pickling. In this evaluation it was found that the PIB4MM and PIB8 MM products do not cause localized corrosion on carbon steel, AISI 316 stainless steel nor in L-80-Cr-13 steel, as shown in FIG. 12. This result is important to ensure integrity of the system with the use of the product.

### 3.7 Dynamic Stability

The dynamic stability test simulates the more extreme conditions in which the product will be subjected, such as low speeds, high pressures, high and low temperatures. The product has been tested in a closed circuit, passing through a cold shower and then a hot shower, and must be stable under a minimum pressure of 15 mPa, T=110° C. and T=4° C. for 336 hours at maximum injection flow rate of 5 mL/min.

After 336 hours, the PIB4MM and PIB8 MM products do not showed a significant increase in the differential pressure of the system, indicating that there was no deposition of material in the filters, at temperatures of 4° C. and 110° C. The appearance of products after the dynamic stability test showed that the products presented no change in color, separation phases, sludge formation or any other abnormality. The evaluation of the viscosity of the product, after the test, showed that both products remained with lower viscosity at 100 mPa·s.

### 3.8 Viscosity

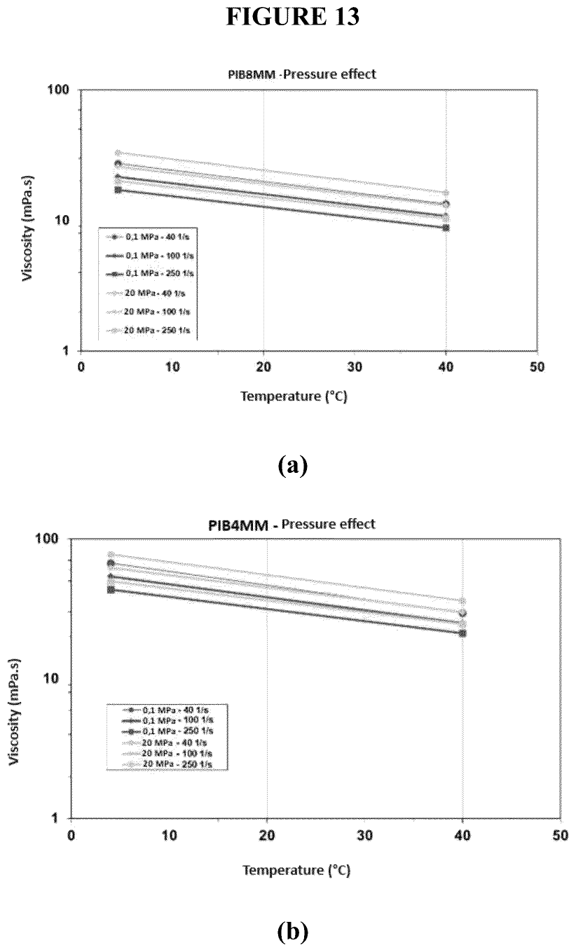

FIG. 13 shows the results of viscosity obtained for the PIB4MM and PIB8 MM formulations, at atmospheric pressure and 20 mPa, in different temperatures at shear rates. As can be observed, in all cases evaluated the values of viscosity are less than 100 mPa·s.

### 3.9 Specific Mass

The specific mass values of the products in three temperatures, including 4° C., under atmospheric pressure, are shown in Table II.

TABLE II
Density of Formulations of Friction Reducing
Agent as a Function of Temperature

| | Specific mass (g/cm³) | | |
|---|---|---|---|
| Formulation | 4° C. | 20° C. | 40° C. |
| PIB8MM | 0.81287 | 0.8029 | 0.78721 |
| PIB4MM | 0.83054 | 0.8189 | 0.8053 |

### Example 4: Assessing the Impact of Formulations of Friction Reducing Agent in Primary Oil Processing

The impact of PIB4MM and PIB8 MM formulations of friction reducing agent in primary oil processing was carried out by evaluating, in the laboratory, the influence of these additives in the gravitational separation of water and oil gas. The oil samples used for this evaluation were the oil from the pre-salt wells of the scenarios I and II. Table III shows the water content and density of these oil samples.

TABLE III
Physical Characterization of Oil Samples

| Sample | Water content (% m/m) | Density (°API) |
|---|---|---|
| Scenario I | 0.10 | 27.4 |
| Scenario II | 0.48 | 29.4 |

4.1 Evaluation of Water Separation from Oil

Evaluation of the influence of PIB4MM and PIB8 MM friction reducing agent in water separation from oil was carried out in the laboratory, through comparison of water separation kinetics from synthetic emulsions, in the absence and presence of the formulations, as well as by visual comparison of the quality of the separated water.

Water-in-oil (W/O) type synthetic emulsions were prepared in the laboratory, from of dehydrated oil samples or with low water and sediment contents. The emulsion was prepared with 30% (v/v) saline water, containing 50 g NaCl/L. The oil phases used were doped with 100 ppm, 1,000 ppm and 10,000 ppm of the PIB4MM and PIB8 MM formulations of friction reducing agent in the oily phase, before adding saline water.

Manual agitation followed by mechanical agitation in the Ultraturrax T-16 homogenizer, at 8,000 rpm for three minutes, was initially used to promote the dispersion of the aqueous phase in the oily phase.

Water separation kinetics were quantified by recording the volume of separated water as a function of time. The percentage of separated water was defined as the ratio between the volume of separated water and the volume of the water initially emulsified in the oil. The tests were carried out in duplicate.

Briefly, the water separation test was carried out in the following way:
initially, the emulsion was transferred to a tube graduated to 100 mL and heated to the test temperature;
the demulsifying product has been added and the graduated tube, containing the fluids, was homogenized with the aid of a Tecnal shaking table, model TE-4200, at 250 rpm per 1 minute;
the tubes were transferred to the thermostatic bath, at the test temperature, and monitoring the phase separation kinetics was started;
finally, the volume of separated water was recorded depending on time, for 15 minutes.

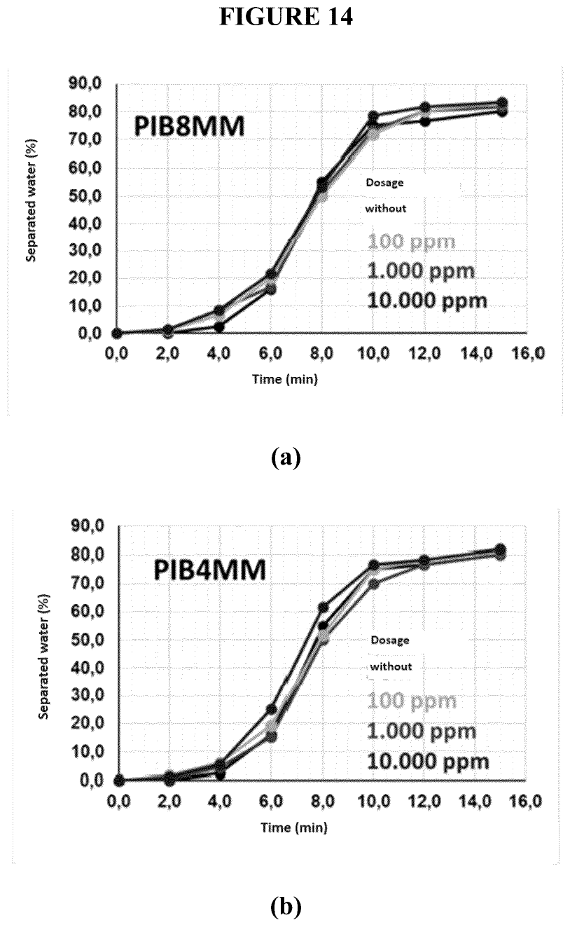

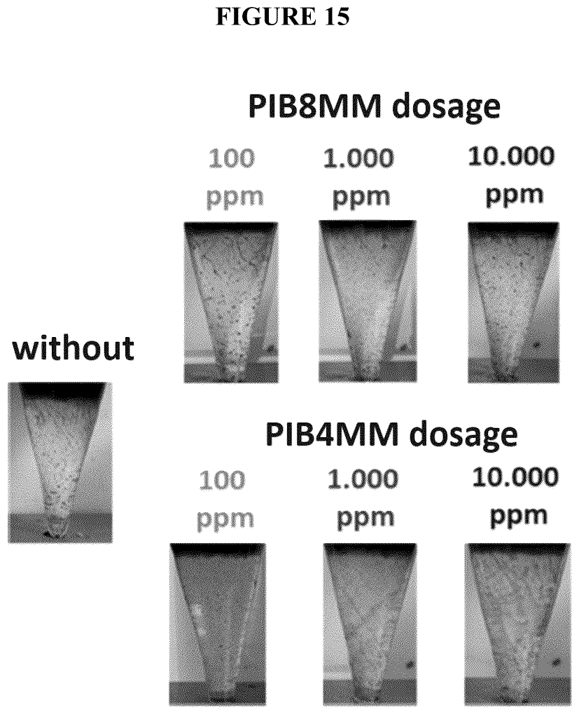

Table IV and FIG. 14 show the water separation results obtained from well emulsion of SCENARIO I, with the addition of 50 ppm of poly(ethylene oxide)-poly(propylene oxide) block copolymer-based demulsifier commercially available at temperature of 40° C. FIG. 15 shows the appearance of separated water from emulsion of the well of SCENARIO I.

TABLE IV
Influence of Formulations of Friction Reducing Agent in
the Separation of Water from the Emulsion of SCENARIO
I, with Addition of 50 ppm of demulsifier, at 40° C.

| | | Time (min) | | | | | | | |
|---|---|---|---|---|---|---|---|---|---|
| Formula- | Dosage | 0 | 2 | 4 | 6 | 8 | 10 | 12 | 15 |
| tion | (ppm) | Separated water (%) | | | | | | | |
| without | — | 0.0 | 0.0 | 2.5 | 15.8 | 55.0 | 75.0 | 76.7 | 80.0 |
| PIB8MM | 100 | 0.0 | 0.8 | 8.3 | 16.7 | 51.7 | 73.3 | 80.0 | 81.7 |
| | 1,000 | 0.0 | 1.3 | 6.7 | 20.0 | 50.0 | 71.7 | 80.0 | 83.3 |
| | 10,000 | 0.0 | 8.3 | 21.7 | 53.3 | 78.3 | 81.7 | 83.3 | 83.3 |
| PIB4MM | 100 | 0.0 | 0.7 | 4.3 | 15.0 | 50.0 | 70.0 | 76.7 | 80.0 |
| | 1,000 | 0.0 | 1.7 | 5.8 | 19.2 | 51.7 | 75.0 | 78.3 | 81.7 |
| | 10,000 | 0.0 | 1.3 | 5.5 | 25.0 | 61.7 | 76.7 | 78.3 | 81.7 |

By analyzing Table IV and FIGS. 14 and 15, it is verified that:
the addition of up to 10,000 ppm of PIB4MM and PIB8 MM formulations of friction reducing agent did not interfere with the kinetics of water separated from the oil in the well in SCENARIO I;
visually, no difference in quality was observed of water separated from the emulsion of SCENARIO I, regardless of the formulation or dosage applied.

Due to the fact that PIB4MM and PIB8 MM formulations of friction reducing agent did not interfere in the separation of water from oil in SCENARIO I, the tests to evaluate the impact of separating water from oil in SCENARIO II were performed only at the highest dosage (10,000 ppm).

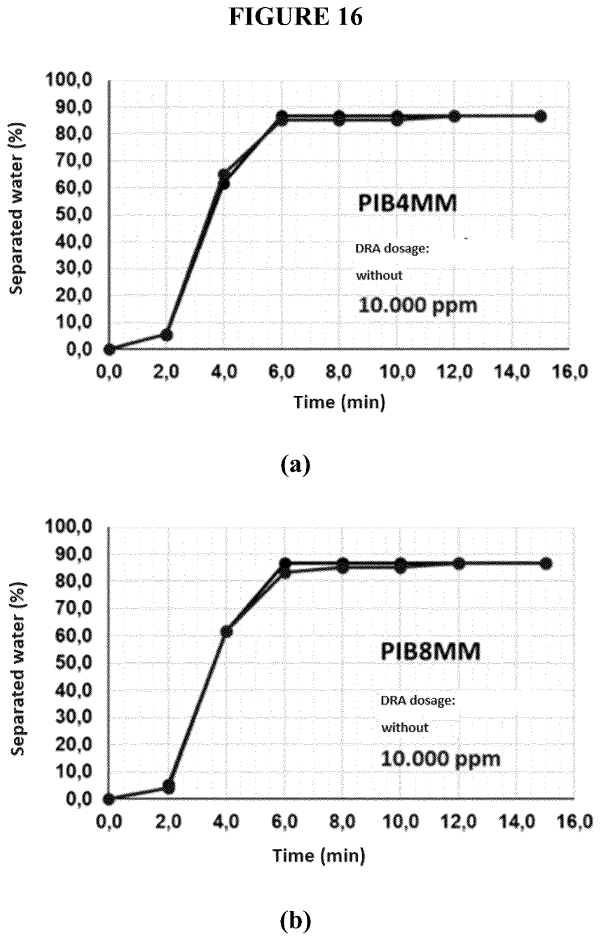

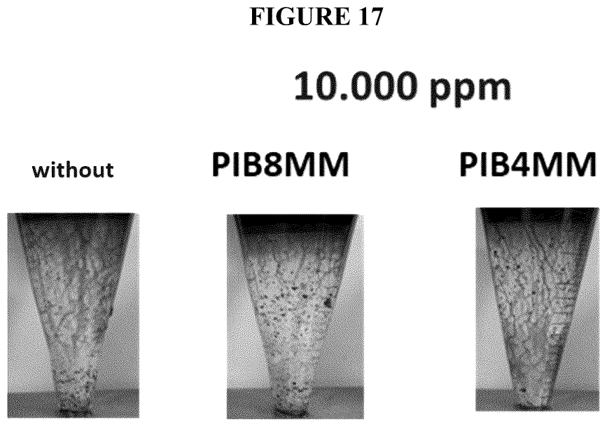

Table V and FIG. 16 show the results of water separation obtained from the emulsion from the well of SCENARIO II, with the addition of 50 ppm of poly(ethylene oxide)-poly(propylene oxide) block copolymers-based demulsifying product commercially available at temperature of 50° C. FIG. 17 shows the appearance of water separated from emulsion of the well of SCENARIO II.

TABLE V
Influence of Formulations of Friction Reducing Agent
in the Separation of Water from Emulsion of SCENARIO
II, with Addition of 50 ppm of demulsifier, at 50° C.

| | | Time (min) | | | | | | | |
|---|---|---|---|---|---|---|---|---|---|
| Formula- | Dosage | 0 | 2 | 4 | 6 | 8 | 10 | 12 | 15 |
| tion | (ppm) | Separated water (%) | | | | | | | |
| without | — | 0.0 | 5.3 | 61.7 | 86.7 | 86.7 | 86.7 | 86.7 | 86.7 |
| PIB8MM | 10,000 | 0.0 | 5.5 | 65.0 | 85.0 | 85.0 | 85.0 | 86.7 | 86.7 |
| PIB4MM | 10,000 | 0.0 | 4.2 | 61.7 | 83.3 | 85.0 | 85.0 | 86.7 | 86.7 |

By analyzing Table V and FIGS. 16 and 17, it is verified that:
the addition of 10,000 ppm of the PIB4MM and PIB8 MM formulations of friction reducing agent did not interfere with the kinetics of water separated from the oil in the well of SCENARIO II;
visually, no difference in quality was observed of water separated from the emulsion of SCENARIO II, regardless of the added formulation.
   4.2 Evaluation of the Separation of Gas from Oil

The influence of the PIB4MM and PIB8 MM formulations of friction reducing agent in the separation of gas from oil was evaluated, in the laboratory, through the test that evaluates the tendency to the formation and breakdown of foam in oil, in absence and presence of the formulations, through compression of oil (at 1,379 MPa-200 psi) and subsequent decompression of fluids at atmospheric pressure. Then, it was carried out monitoring the formation and decay of foam, over time. The PIB4MM and PIB8 MM formulations of friction reducing agents were evaluated in the presence of high silicon content defoamer and with proven performance in field in the fight against foam.

Briefly, the tests were carried out in the following way:
initially, the oil, whether or not added with the chemical product, was compressed with nitrogen, inside of the compression cell, at a pressure of 1.379 MPa (200 psi), at room temperature;
then, oil and nitrogen reach equilibrium, the oil was decompressed at atmospheric pressure, to inside a measuring cylinder, and the formation and the decay of the foam inside the beaker was quantified, over the time.

To evaluate the influence of formulations on foam formation and breaking, when possible, the following indices were calculated: Difference of Foam Initially Formed (DEF) and Defoamer Index (ICE).

DEF is based on the difference between foam formed between tests without the presence of defoamer additive and in the presence of defoamer additive, as shown in equation 2. It is noteworthy that the higher the DEF value, the greater the action of the additive in preventing foaming (antifoaming action).

$$DEF = E S P 15 s - E C P 15 c \qquad ( 2 )$$

where:
ESP15s=percentage of foam in the time of 15 seconds of the test without defoamer;
ECP15c=percentage of foam in time of 15 seconds of the test with 20 ppm of defoamer additive;

The ICE is based on comparing the sum of foam values obtained in the test without the addition of chemical product with the sum of the foam values in the test with the product addition. The equation 3 describes the formula used to calculate the ICE. It is worth noting that the higher the value of ICE for an additive product, the higher is considered its performance in combating oil foam, that is, greater is its antifoaming and/or defoaming action, in the laboratory.

$$ICE = \frac{( \sum ( \% ) ESP - \sum ( \% ) ECP )}{\sum ( \% ) ESP} \qquad ( 3 )$$

where;
Σ(%)E—sum of foam (%) obtained at all times in a test;
Σ(%)ESP—sum of foam (%) obtained in the test without the chemical product (SP);
Σ(%)ECP—sum of foam (%) obtained in the test with the chemical product (CP).

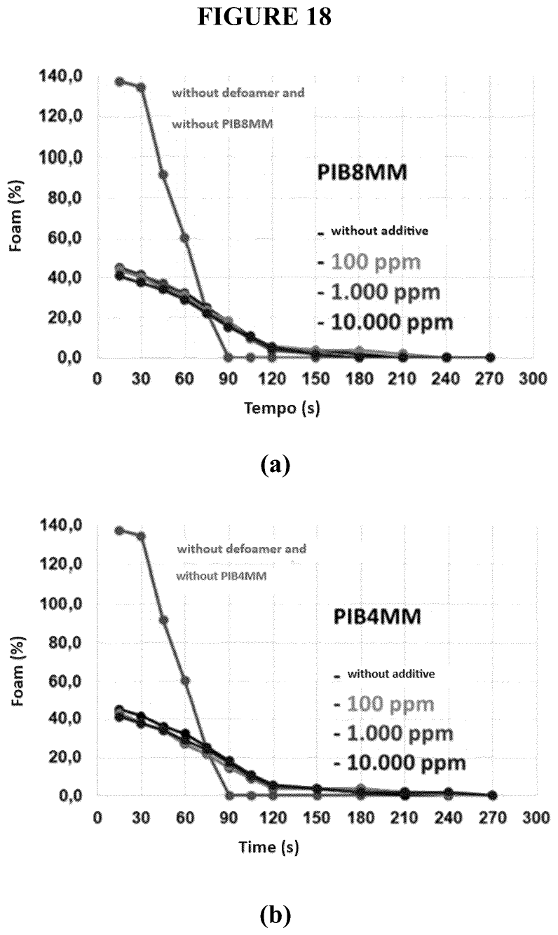

Table VI and FIG. 18 show the results, in laboratory, of the formation and decay of foam in the oil in SCENARIO I, as a function of time, in the absence and presence of 20 ppm of defoamer and at room temperature.

TABLE VI
Influence of the PIB4MM and PIB8MM Formulations of Friction Reducing Agent in the Formation
and Breakdown of Foam in Oil from SCENARIO I at Room Temperature, in Laboratory

| | Foam (%) | | | | | | | |
|---|---|---|---|---|---|---|---|---|
| | | 20 ppm of high content defoamer | | | | | | |
| | | without | | | | | | |
| Time | without | friction | PIB8MM | | | PIB4MM | | |
| (s) | defoamer | reducer | 100 ppm | 1,000 ppm | 10,000 ppm | 100 ppm | 1,000 ppm | 10,000 ppm |
| 15 | 137.1 | 44.6 | 44.4 | 43.6 | 40.7 | 40.4 | 42.9 | 40.7 |
| 30 | 134.3 | 41.1 | 40.7 | 40.0 | 37.3 | 38.6 | 37.5 | 37.3 |
| 45 | 91.4 | 35.7 | 37.0 | 34.5 | 33.9 | 33.3 | 33.9 | 33.9 |
| 60 | 60.0 | 32.1 | 31.5 | 30.9 | 28.8 | 28.1 | 26.8 | 28.8 |
| 75 | 22.9 | 25.0 | 22. | 23.6 | 22.0 | 24.6 | 21.4 | 23.7 |
| 90 | 0.0 | 17.9 | 17.9 | 17.9 | 17.9 | 17.9 | 17.9 | 17.9 |
| 105 | 0.0 | 10.7 | 9.3 | 9.1 | 10.2 | 14.0 | 8.9 | 10.2 |
| 120 | 0.0 | 5.4 | 3.7 | 5.5 | 5.1 | 7.0 | 3.6 | 5.1 |
| 150 | 0.0 | 3.6 | 1.9 | 3.6 | 1.7 | 3.5 | 3.6 | 3.4 |
| 180 | 0.0 | 1.8 | 0.0 | 3.6 | 0.0 | 3.5 | 3.6 | 1.7 |
| 210 | 0.0 | 0.0 | 0.0 | 1.8 | 0.0 | 1.8 | 1.8 | 1.7 |
| 240 | 0.0 | 0.0 | 0.0 | 0.0 | 0.0 | 0.0 | 0.0 | 1.7 |
| 270 | 0.0 | 0.0 | 0.0 | 0.0 | 0.0 | 0.0 | 0.0 | 0.0 |
| Σ (%) E | 445.7 | 217.9 | 207.4 | 214.5 | 194.9 | 214.0 | 198.2 | 205.1 |

| | | | | | | | |
|---|---|---|---|---|---|---|---|
| DEF | 92.5 | 92.7 | 93.5 | 96.5 | 96.8 | 94.3 | 96.5 |
| ICE | 0.51 | 0.53 | 0.52 | 0.56 | 0.52 | 0.56 | 0.54 |

By analyzing the results contained in Table VI and FIG. 18, it is verified that:
although the high silicon defoamer product, consisting of a solution containing 30% polydimethylsiloxane (63148-62-9) in hydrotreated light oil distillates, used as a reference, for use in units of primary oil processing, has shown defoamer action (DEF of 92.5%) on oil, this showed an increase in the foam decay time in the test carried out in the laboratory with oil from SCENARIO I in dosage of 20 ppm of product at room temperature;
the addition of the PIB8 MM formulation, in dosages from 100 ppm to 10,000 ppm, to oil, did not provide significant change in the foam initially formed (DEF between 92.7 and 96.5) and no significant change in the foam breaking time in relation to oil containing defoamer. Thus, there was no significant change in the ICE due to the addition of the formulation;
the addition of the PIB4MM formulation, in dosages from 100 ppm to 10,000 ppm, to oil, did not provide significant change in the foam initially formed (DEF between 94.6 and 96.8) and no significant change in the foam breaking time in relation to oil containing defoamer. Thus, there was no significant change in the ICE due to the addition of the formulation.

Due to the fact that the PIB4MM and PIB8 MM formulations have not interfered in the separation of gas from oil of SCENARIO I, the tests to evaluate the impact of the separation of gas from oil of SCENARIO II were carried out only in higher dosage of additives (10,000 ppm).

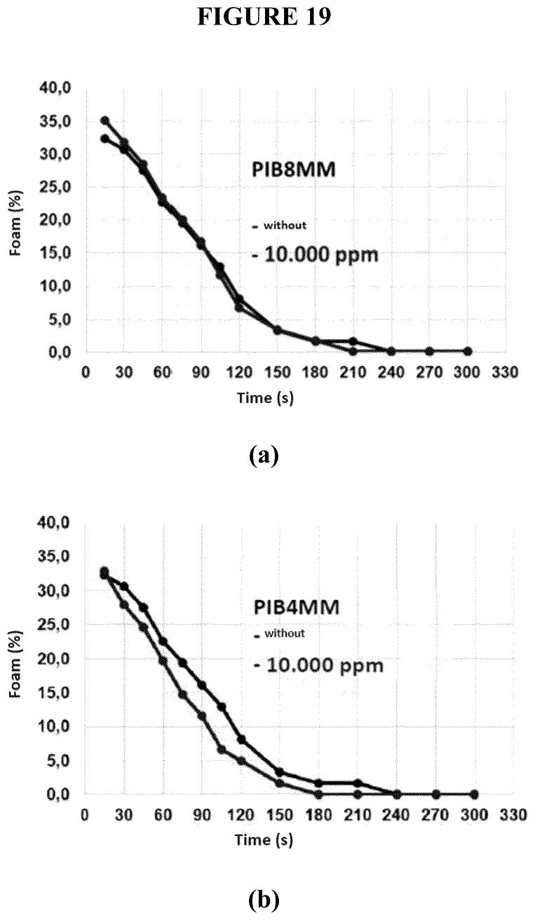

Table VII and FIG. 19 show the results, in laboratory, of the formation and decay of foam in the oil in SCENARIO II, as a function of time. It should be highlighted that this oil sample already contains defoamer, which was added upstream of the sampling point, in the field. Therefore, only tests without and with the addition of the PIB4MM and PIB8 MM formulations were carried out.

TABLE VII
Influence of the PIB4MM and PIB8MM Formulations of Friction
Reducing Agent in the Formation and Breakdown of Foam in
the Oil of SCENARIO II at Room Temperature, in Laboratory

| | Formulation | | |
|---|---|---|---|
| | without | PIB8MM | PIB4MM |
| Time (s) | addition | 10,000 ppm | 10,000 ppm |
| 15 | 32.3 | 35.0 | 32.8 |
| 30 | 30.6 | 31.7 | 27.9 |
| 45 | 27.4 | 28.3 | 24.6 |
| 60 | 22.6 | 23.3 | 19.7 |
| 75 | 19.4 | 20.0 | 14.8 |
| 90 | 16.1 | 16.7 | 11.5 |
| 105 | 12.9 | 11.7 | 6.6 |
| 120 | 8.1 | 6.7 | 4.9 |
| 150 | 3.2 | 3.3 | 1.6 |
| 180 | 1.6 | 1.7 | 0.0 |
| 210 | 1.6 | 0.0 | 0.0 |
| 240 | 0.0 | 0.0 | 0.0 |
| 270 | 0.0 | 0.0 | 0.0 |
| 300 | 0.0 | 0.0 | 0.0 |
| 330 | 0.0 | 0.0 | 0.0 |
| Σ(%)E | 175.8 | 178.3 | 144.3 |

By analyzing the results contained in Table VII and in FIG. 19, it is verified that the addition of the formulations of friction reducing agent of the invention, both in the dosage of 10,000 ppm, to the oil provided no significant change in the foam initially formed and no significant change in the foam breaking time in relation to the oil.

### BIBLIOGRAPHIC REFERENCES

Bizotto, V. C. Uma revisão sobre o efeito Toms—O fenõmeno onde macromoléculas atenuam a turbul\tilde{e}ncia em um liquido. Quimica Nova, volume 34, number 4, pages 658 to 664, 2011.
Toms, B. A. In Proceeding of the First International Congress on Rheology, 1948, page 135.
Bailey, F. E.; Koleske, J. V.; Poly(ethylene oxide), Academic Press Inc.: New York, 1976.
Al-Wahaibi, T. et al. Roles of Drag reducing polymers in single- and multi-phase flows. Chemical Engineering Research and Design. 2014, 92, 2153 to 2181.
Jubran, B. A.; Zurigat, Y. H.; Goosen, M. F. A. Drag Reducing Agents in Multiphase Flow Pipelines: Recent Trends and Future Needs. Oil Science and Technology, 2005, 23:11-12, 1403 to 1424.
Lee, P. F. W.; Duffy, G. G. Relationships between velocity profiles and drag reduction in turbulent fiber suspension flow. AIChE Journal, 1976, 22, 4, 750 to 753.
Yu B, Li F, Kawaguchi Y. Numerical and experimental investigation of turbulent characteristics in a drag-reducing flow with surfactant additives. Int J Heat Fluid Flow 2004; 25, 961 to 974.
Krope A, Lipus L C. Drag reducing surfactants for district heating. Appl Therm Eng, 2010, 30, 833 to 838.
White, C. M.; Mungal, M. G. Mechanics And Prediction Of Turbulent Drag Reduction Whit Polymer Additives, Ann. Rev. Fluid Mech. 40, 2008, 235 to 256.
Soares, E. J.; et al. Loss of efficiency of polymeric drag reducers induced by high Reynolds number flows in tubes with imposed pressure. Physics of Fluids, 2015, 27, 12, 125105.
Kotenko, M.; Oskarsson, H.; Bojesen; C.; Nielsen, M. P. An experimental study of the drag reducing surfactant for district heating and cooling. Energy, 2019, 178, 72 to 78.

1. A formulation of friction reducing agent, comprising a polyisobutylene of molecular weight from 4 MM to 8 MM and a mineral oil.

2. The formulation of friction reducing agent, according to claim 1, wherein the polyisobutylene has a molecular weight of 4 MM or 8 MM.

3. The formulation of friction reducing agent, according to claim 1, wherein the polyisobutylene has a concentration of 5,000 to 15,000 ppm.

4. The formulation of friction reducing agent, according to claim 1, wherein the polyisobutylene has a concentration of 5,000 ppm.

5. The formulation of friction reducing agent, according to claim 1, wherein the mineral oil comprises derivatives of monoakylbenzene, hydrotreated light oil distillates, or mixtures thereof.

6. The formulation of friction reducing agent, according to claim 5, wherein the mineral oil comprises hydrotreated light oil distillates.

7. The formulation of friction reducing agent, according to claim 5, wherein the mineral oil comprises a mixture of derivatives of monoakylbenzene and hydrotreated light oil distillates.

8. The formulation of friction reducing agent, according to claim 1, wherein the formulation of friction reducing agent reduces friction in turbulent flow and is suitable for subsea injection through umbilical route into a wet Christmas tree, umbilical route located at a bottom of a well, through a chemical injection valve (downhole) or through a gas injection valve in the well (gas lift).

9. The formulation of friction reducing agent, according to claim 1, wherein the formulation of friction reducing agent is being-suitable for subsea injection in production with wet completion and two-phase (liquid-gas) and multiphase (liquid-liquid-gas) turbulent flow with a gas-oil ratio (GOR) of 150 to 1,500 m³/m³.

10. A method for reducing friction in turbulent flow, comprising a subsea injection of the formulation of friction reducing agent, as defined in claim 1, wherein the subsea injection is given through an umbilical route in a wet Christmas tree, the umbilical route located at a bottom of a well, through a chemical injection valve (downhole) or through a gas injection valve into the well (gas lift).

11. The method, according to claim 10, wherein the subsea injection takes place through the umbilical route on the wet Christmas tree.

12. The method, according to claim 10, comprising: (i) injecting the formulation of friction reducing agent at an end of a first umbilical located in a surface; (ii) transporting the formulation of friction reducing agent by the first umbilical to a subsea environment; and (iii) injecting the formulation of friction reducing agent in a second umbilical with a fluid with two-phase or multiphase (liquid-liquid-gas) turbulent flow (liquid-gas).

13. The method, according to claim 10, wherein the formulation of friction reducing agent is applied at a concentration of 0.05% to 5%.

14. The method, according to claim 10, wherein the formulation of friction reducing agent is applied at a concentration of 5%.

15. The method, according to claim 10, wherein the method is for reducing friction in a subsea turbulent flow of low-density oils.

16. The method, according to claim 15, wherein a water content in the subsea turbulent flow is less than 10%, a Reynolds number at the subsea turbulent flow is greater than 10,000, and/or a flow velocity is less than 4.6 m/s.

17. A use of the formulation of friction reducing agent, as defined in claim 1, wherein the formulation of friction reducing agent is for reducing friction in a two-phase turbulent flow, wherein the formulation of friction reducing agent is for a subsea injection through an umbilical into a wet Christmas tree, umbilical route located at a bottom of a well, through a chemical injection valve (downhole) or through a gas injection valve in the well (gas lift).

18. The use, according to claim 17, wherein the use is to reduce friction in a turbulent flow of low-density oil.

19. The use, according to claim 18, wherein a water content in the turbulent flow is less than 10%, a Reynolds number in the turbulent flow is greater than 10,000, and/or a flow velocity is less than 4.6 m/s.
